(19) United States
(12) Patent Application Publication
(10) Pub. No.: US 2026/0285239 A1
(43) Pub. Date: Sep. 24, 2026

(54) VEHICLE UPPER STRUCTURE

(71) Applicant: TOYOTA BOSHOKU KABUSHIKI KAISHA, Aichi-ken (JP)

(72) Inventors: Hirokazu HIRANO, Kariya-shi (JP); Masayuki TATSUHARA, Kariya-shi (JP); Atsushi GOMI, Kariya-shi (JP); Yoichi SAKOTA, Toyota-shi (JP); Mitsuaki ESHIMA, Okazaki-shi (JP); Takatsugu NAGATA, Toyota-shi (JP)

(73) Assignee: TOYOTA BOSHOKU KABUSHIKI KAISHA, Aichi-ken (JP)

(21) Appl. No.: 19/357,734

(22) Filed: Oct. 14, 2025

(30) Foreign Application Priority Data
Oct. 17, 2024 (JP) 2024-182037

(51) Int. Cl. B60R 11/00; B60R 7/04

(52) U.S. Cl. CPC B60R 11/00; B60R 7/04; B60R 2011/0028

(57) ABSTRACT

A vehicle upper structure includes an overhead console provided on a ceiling of a passenger compartment, a device unit fixed to an upper portion of a windshield, and a cover that covers the device unit from inside the passenger compartment. The cover and the overhead console are arranged in a longitudinal direction of the vehicle. The cover includes a cover body located forward of the overhead console and an overlap portion extending upward and rearward from a rear end of the cover body. A front portion of the overhead console covers the overlap portion from below.

### BACKGROUND

The present disclosure relates to a vehicle upper structure.

JP2022-155010A discloses a vehicle upper structure including an overhead console provided on the ceiling of a passenger compartment, a sensor unit fixed to an upper portion of a windshield, and a sensor cover that covers the sensor unit from inside the passenger compartment.

In recent years, as the number and types of sensors have increased, the size of the sensor cover accommodating such sensors has continued to grow. To provide an increased accommodation space, it has become desirable to integrate the sensor cover and the overhead console so that they are arranged continuously in the vehicle longitudinal direction.

Manufacturing and assembly tolerances can cause variations in the positional relationship between the sensor cover and the overhead console. When the positional relationship between the sensor cover and the overhead console deviates from the desired configuration, the aesthetic appearance of the integrated vehicle upper structure may be impaired. In particular, if a gap is formed between a rear portion of the sensor cover and a front portion of the overhead console in the vehicle longitudinal direction, the continuity between the two components is disrupted. This tends to impair the aesthetic appearance of the vehicle upper structure.

### SUMMARY

In one general aspect, a vehicle upper structure includes an overhead console provided on a ceiling of a passenger compartment, a device unit fixed to an upper portion of a windshield, and a cover that covers the device unit from inside the passenger compartment. The cover and the overhead console are arranged in a longitudinal direction of the vehicle. The cover includes a cover body located forward of the overhead console, and an overlap portion extending upward and rearward from a rear end of the cover body. A front portion of the overhead console covers the overlap portion from below.

### BRIEF DESCRIPTION OF THE DRAWINGS

The features of the present disclosure that are believed to be novel are set forth with particularity in the appended claims. The disclosure, together with objects and advantages thereof, may best be understood by reference to the following description of the presently preferred embodiments together with the accompanying drawings.

FIG. 1 is a schematic diagram showing a vehicle upper structure as viewed from inside the passenger compartment.

FIG. 2 is a schematic diagram showing the vehicle upper structure as viewed from the roof.

FIG. 3 is a plan view showing a front attachment portion.

FIG. 4 is a cross-sectional view of the front attachment portion taken along line 4 -4 in FIG. 3.

FIG. 5 is a cross-sectional view showing a rear attachment portion.

FIG. 6 is a cross-sectional view of the rear attachment portion taken along line 6 -6 in FIG. 5.

FIG. 7 is a cross-sectional view showing the vehicle upper structure.

### DETAILED DESCRIPTION

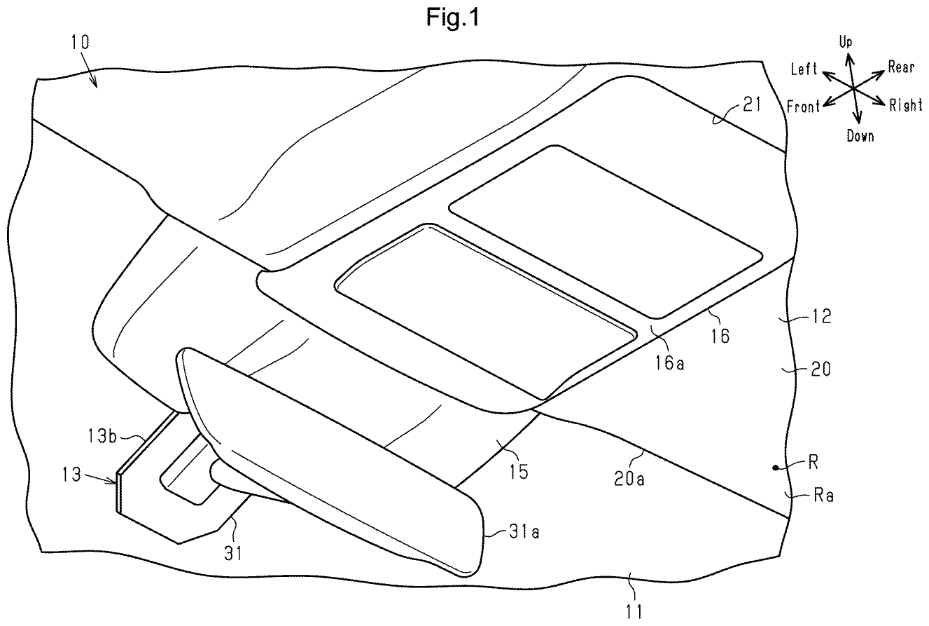

A vehicle upper structure according to an embodiment will now be described with reference to FIGS. 1 to 7. In the following description, the frontward, rearward, leftward, rightward, upward, and downward directions are defined with reference to a state in which the driver of the vehicle faces the forward direction (advancing direction). The left-right direction corresponds to the vehicle width direction.

As shown in FIG. 1, a vehicle 10 includes a windshield 11 and a roof 12. The roof 12 includes a roof lining 20 and a roof panel (not shown). The roof lining 20 forms a ceiling Ra of a passenger compartment R. The roof panel is located above the roof lining 20. The roof lining 20 covers the roof panel from inside the passenger compartment R.

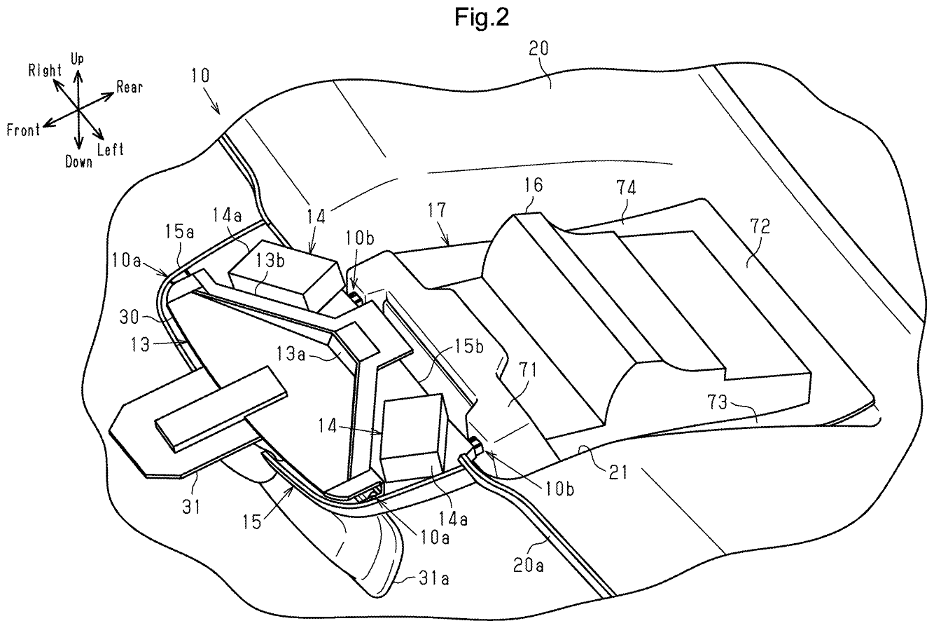

As shown in FIG. 2, the roof lining 20 includes a recess 21 that extends from a front edge 20a toward the rear of the vehicle 10. The recess 21 is provided in a central portion of the roof lining 20 in the vehicle width direction.

The vehicle 10 includes a camera unit 13 as a device unit. The camera unit 13 includes a camera 13a and a camera bracket 13b that holds the camera 13a. The camera 13a captures images of an area in front of the vehicle 10. The camera bracket 13b is attached to an upper portion of the surface of the windshield 11 facing the passenger compartment R. Accordingly, the camera unit 13 is fixed to the upper portion of the windshield 11 in the passenger compartment R. The camera bracket 13b of the present embodiment forms a windshield-side bracket fixed to the windshield 11. The camera bracket 13b of the present embodiment includes a bracket body 30 and a mirror mounting portion 31 extending forward from the bracket body 30. A rearview mirror 31a is mounted to the mirror mounting portion 31.

The vehicle 10 includes two sensor units 14 as device units. Each sensor unit 14 includes a sensor (not shown) and a sensor case 14a, in which the sensor is accommodated. The sensor case 14a is attached to an upper portion of the surface of the windshield 11 facing the passenger compartment R. Accordingly, the sensor unit 14 is fixed to the upper portion of the windshield 11 in the passenger compartment R.

The vehicle 10 includes a cover 15 that covers the device units from inside the passenger compartment R. The cover 15 of the present embodiment covers the camera 13a of the camera unit 13, the bracket body 30 of the camera bracket 13b, and the two sensor units 14 from inside the passenger compartment R. An edge of the cover 15 of the present embodiment is bent so as to extend toward the windshield 11. As will be described below, a front portion 15a of the cover 15 is attached to the camera bracket 13b. A rear portion 15b of the cover 15 is attached to a roof-side bracket 17, which will be discussed below.

As shown in FIG. 1, the vehicle 10 includes an overhead console 16. The overhead console 16 is provided on a ceiling Ra of the passenger compartment R. The overhead console 16 is fixed to the roof panel. The overhead console 16 is located inside the recess 21 of the roof lining 20. A lower surface 16a of the overhead console 16 is exposed to the passenger compartment R. A map light, a switch, an accommodating portion, and the like (not shown) are provided on a lower surface 16a of the overhead console 16.

The cover 15 and the overhead console 16 are arranged in the longitudinal direction of the vehicle 10. The overhead console 16 is located rearward of the cover 15. The roof lining 20 is not provided between the cover 15 and the overhead console 16. Accordingly, the cover 15 and the overhead console 16 are arranged continuously in the longitudinal direction of the vehicle 10. A harness (not shown) routed into the cover 15 from inside the roof 12 across the boundary between the cover 15 and the overhead console 16 is connected to each device unit.

As shown in FIG. 2, the vehicle 10 includes a roof-side bracket 17. The roof-side bracket 17 of the present embodiment has the shape of a rectangular frame. The roof-side bracket 17 includes a front frame portion 71, a rear frame portion 72, a left frame portion 73, and a right frame portion 74. Each of the front frame portion 71 and the rear frame portion 72 extends in the vehicle width direction. The rear frame portion 72 is located rearward of the front frame portion 71. The left frame portion 73 connects the left end of the front frame portion 71 to the left end of the rear frame portion 72 in the longitudinal direction. The right frame portion 74 connects the right end of the front frame portion 71 and the right end of the rear frame portion 72 in the longitudinal direction.

The roof-side bracket 17 is provided inside the roof 12. The roof-side bracket 17 is provided between the roof panel and the roof lining 20. The roof-side bracket 17 is disposed so as to surround the overhead console 16. The roof-side bracket 17 is fixed to the roof lining 20. In the present embodiment, the lower surface of the roof-side bracket 17 is fixed to the roof lining 20 with an adhesive.

The vehicle 10 includes front attachment portions 10a, which attach the front portion 15a of the cover 15 to the camera bracket 13b, and rear attachment portions 10b, which attach the rear portion 15b of the cover 15 to the roof-side bracket 17. The present embodiment includes two front attachment portions 10a spaced apart in the vehicle width direction and two rear attachment portions 10b.

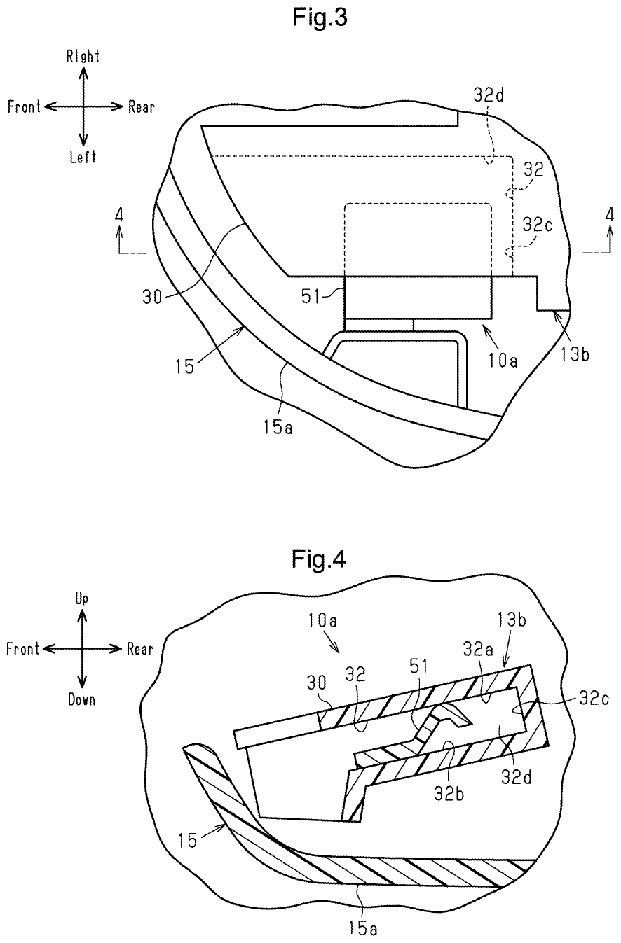

As shown in FIGS. 3 and 4, each front attachment portion 10a of the present embodiment includes a front protrusion 51 provided on the cover 15 and a groove 32 provided in the camera bracket 13b. FIGS. 3 and 4 show one of the two front attachment portions 10a that is located on the left side.

The front protrusions 51 are provided on the front portion 15a of the cover 15. In the present embodiment, the front protrusions 51 are provided at the opposite ends of the cover 15 in the vehicle width direction. Each front protrusion 51 protrudes from the cover 15 toward the bracket body 30 of the camera bracket 13b. In the left one of the two front attachment portions 10a, the front protrusion 51 protrudes rightward from the cover 15 at a position where the left edge is bent. In the right one of the two front attachment portions 10a, the front protrusion 51 protrudes leftward from the cover 15 at a position where the right edge is bent.

The grooves 32 are provided in the bracket body 30. In the present embodiment, the grooves 32 are provided at the opposite ends of the bracket body 30 in the vehicle width direction. Each groove 32 is recessed rearward from the front surface of the bracket body 30. In the left one of the two front attachment portions 10a, the groove 32 is open in the left surface of the bracket body 30. In the right one of the two front attachment portions 10a, the groove 32 is open in the right surface of the bracket body 30.

The bracket body 30 includes an upper defining surface 32a, a lower defining surface 32b, a first defining surface 32c, and a second defining surface 32d, which together define each of the groove 32. The first defining surface 32c extends in the vehicle width direction. The second defining surface 32d extends in the longitudinal direction.

The front portion 15a of the cover 15 is attached to the camera bracket 13b by inserting the front protrusion 51 into the respective grooves 32. With the front protrusions 51 inserted into the respective grooves 32, the upper surface of each front protrusion 51 is in contact with the corresponding upper defining surface 32a, and the lower surface of the front protrusion 51 is in contact with the corresponding lower defining surface 32b. In other words, the front protrusion 51 is sandwiched between the upper defining surface 32a and the lower defining surface 32b in the vertical direction. Accordingly, the front portion 15a of the cover 15 is attached to the camera bracket 13b so as to be immovable in the vertical direction.

The front portion 15a of the cover 15 is attached to the camera bracket 13b so as to be movable in the longitudinal direction. Specifically, with the front protrusions 51 inserted in the grooves 32, a clearance is provided between the rear surface of each front protrusion 51 and the corresponding first defining surface 32c. Thus, the front portion 15a of the cover 15 is movable rearward relative to the camera bracket 13b. The grooves 32 are open in the front surface of the bracket body 30. Thus, the front portion 15a of the cover 15 is movable frontward relative to the camera bracket 13b.

The front portion 15a of the cover 15 is attached to the camera bracket 13b so as to be movable in the left-right direction. Specifically, with the front protrusions 51 in the grooves 32, a clearance is provided between each second defining surface 32d and the corresponding front protrusion 51. Further, the grooves 32 are open in the left surface and the right surface of the bracket body 30. Accordingly, the front portion 15a of the cover 15 is movable in the left-right direction relative to the camera bracket 13b.

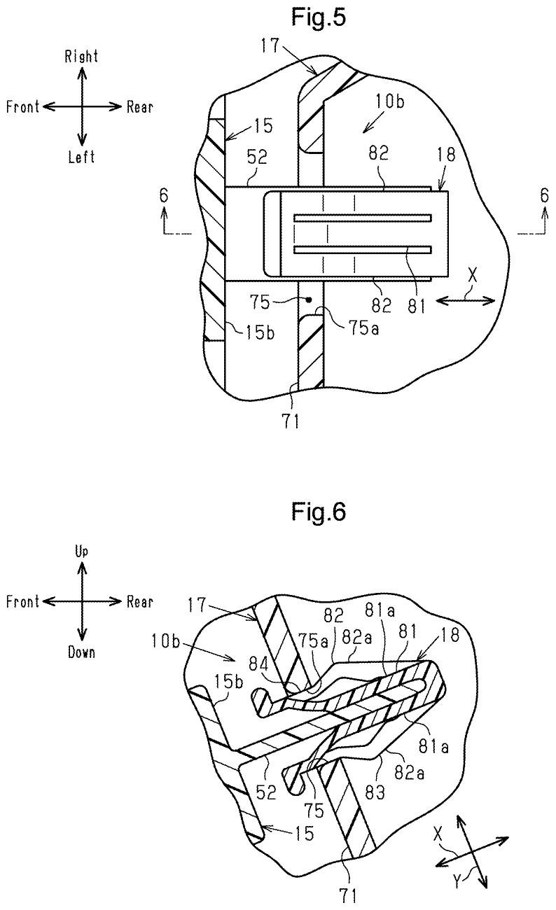

As shown in FIGS. 5 and 6, each rear attachment portion 10b of the present embodiment includes a rear protrusion 52 provided on the cover 15, a clip 18 attached to the rear protrusion 52, and a hole 75 formed in the roof-side bracket 17.

The rear protrusions 52 are provided on the rear portion 15b of the cover 15. In the present embodiment, the rear protrusions 52 are provided at the opposite ends of the cover 15 in the vehicle width direction. The rear protrusions 52 of the present embodiment each have the shape of a thin plate. Each rear protrusion 52 extends upward and rearward from the cover 15. A direction in which each rear protrusion 52 extends from the cover 15 is defined as a first direction X. A direction orthogonal to the first direction X and the vehicle width direction is defined as a second direction Y. The second direction Y is parallel to the thickness direction of the rear protrusion 52.

The clip 18 includes a holding portion 81 for attaching the clip 18 to the rear protrusion 52. The holding portion 81 includes a pair of holding arms 81a extending in the first direction X. The rear protrusion 52 is held in the second direction Y by the pair of holding arms 81a. The clip 18 is thus attached to the rear protrusion 52. The pair of holding arms 81a are connected to each other at the distal end of the rear protrusion 52.

The clip 18 includes locking portions 82 for locking the clip 18 in the corresponding hole 75. In the present embodiment, the locking portions 82 are provided on the opposite sides of the holding portion 81 in the vehicle width direction. Each locking portion 82 includes a pair of locking arms 82a extending in the first direction X. The rear protrusion 52 is located between the locking arms 82a in the second direction Y. The locking arms 82a in each pair are connected to each other at the distal end of the rear protrusion 52.

With the clip 18 attached to the rear protrusion 52, the locking portions 82 are elastically deformable such that the locking arms 82a approach each other. In other words, the elastically deformable clip 18 is attached to the rear protrusion 52. When each locking portion 82 is elastically deformed so that the locking arms 82a approach each other, the dimension of each locking portion 82 in the second direction Y is reduced.

The locking portions 82 each include an enlarged portion 83 and a narrowed portion 84. The enlarged portion 83 is a section in which the dimension in the second direction Y of the locking portion 82 progressively increases from the distal end toward the proximal end in the first direction X of the rear protrusion 52. The narrowed portion 84 is located closer in the first direction X to the proximal end of the rear protrusion 52 than the enlarged portion 83 is. The dimension of the narrowed portion 84 in the second direction Y is smaller than the maximum dimension of the enlarged portion 83 in the second direction Y.

The holes 75 are provided in the front frame portion 71 of the roof-side bracket 17. In the present embodiment, the holes 75 are provided at the opposite ends of the front frame portion 71 in the vehicle width direction. Each of the holes 75 extends through the front frame portion 71 in the first direction X.

In a state in which the locking portions 82 are not elastically deformed, the dimension of the narrowed portions 84 in the second direction Y is greater than or equal to the dimension of the hole 75 in the second direction Y. In the present embodiment, in a state in which each locking portion 82 is not elastically deformed, the dimension of the narrowed portions 84 in the second direction Y is greater than the dimension of the hole 75 in the second direction Y. The dimension of the narrowed portions 84 in the first direction X is greater than the dimension of the hole 75 in the first direction X. The dimension of the rear protrusion 52 in the vehicle width direction is smaller than the dimension of the hole 75 in the vehicle width direction.

The rear protrusion 52 and the clip 18 are inserted through the hole 75. The locking portions 82 of the clip 18 are inserted through the hole 75 by being elastically deformed such that the locking arms 82a approach each other.

In a state in which the rear protrusion 52 and the clip 18 are inserted through the hole 75, the narrowed portions 84 of the locking portions 82 are located inside the hole 75. The locking arms 82a of the locking portions 82 are each in contact with an inner circumferential surface 75a defining the hole 75. Accordingly, the clip 18 is locked to the hole 75. By locking the clips 18 to the holes 75, the rear portion 15b of the cover 15 is attached to the roof-side bracket 17. In the present embodiment, each of the locking arms 82a is pressed against the inner circumferential surface 75a, which defines the hole 75, by the restoring force of the locking portions 82.

In the vertical direction, no clearance is provided between each locking arm 82a of the locking portions 82 and the inner circumferential surface 75a, which defines the hole 75. Accordingly, the rear portion 15b of the cover 15 is attached to the camera bracket 13b so as to be immovable in the vertical direction.

In a state in which the rear protrusions 52 and the clips 18 are inserted through the holes 75, the clips 18 are movable in the longitudinal direction relative to the roof-side bracket 17. As described above, the locking arms 82a are respectively pressed against the inner circumferential surfaces 75a, which define the holes 75, by the restoring force of the locking portions 82. However, the restoring force of the locking portions 82 is merely sufficient to bring the locking arms 82a into contact with the inner circumferential surfaces 75a, which defines the holes 75. Accordingly, when an operator moves the cover 15 in the longitudinal direction, the clips 18 can be moved in the longitudinal direction while respectively being inserted through the holes 75. Therefore, since the clips 18 are elastically deformable, the rear portion 15b of the cover 15 is attached to the roof-side bracket 17 so as to be movable in the longitudinal direction.

In a state in which the rear protrusions 52 and the clips 18 are inserted through the holes 75, the enlarged portions 83 of the clips 18 are located rearward of the holes 75. The maximum dimension of each enlarged portion 83 in the second direction Y is greater than the dimension of each hole 75 in the second direction Y. Accordingly, since the enlarged portions 83 are caught by the rear surface of the front frame portion 71, the clips 18 are prevented from easily falling out of the holes 75.

The rear portion 15b of the cover 15 is attached to the roof-side bracket 17 so as to be movable in the left-right direction. Specifically, a clearance in the vehicle width direction is provided between each of the left surface and the right surface of each rear protrusion 52 and the inner circumferential surface 75a that defines the corresponding hole 75. Accordingly, the rear protrusions 52 and the clips 18 are movable in the left-right direction while being inserted through the holes 75.

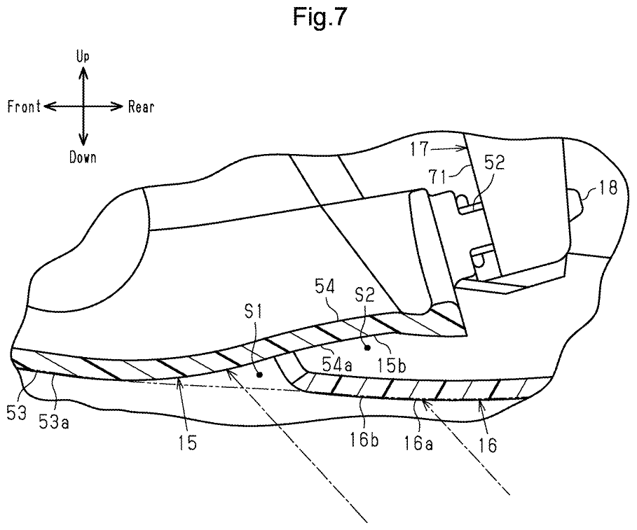

As shown in FIG. 7, the cover 15 includes a cover body 53 and an overlap portion 54. The cover body 53 is located forward of the overhead console 16. The overlap portion 54 extends upward and rearward from the rear end of the cover body 53. The overlap portion 54 extends substantially parallel to the first direction X. The overlap portion 54 forms the rear portion 15b of the cover 15. In the present embodiment, a lower surface 53a of the cover body 53 and a lower surface 54a of the overlap portion 54 are smoothly connected to each other.

A front portion 16b of the overhead console 16 covers the overlap portion 54 from below. In other words, the rear portion 15b of the cover 15 and the front portion 16b of the overhead console 16 overlap each other in the vertical direction in a state in which the cover 15 is located above the overhead console 16. In the present embodiment, the lower surface 53a of the cover body 53 is located on an identical plane with the lower surface 16a of the overhead console 16.

In the present embodiment, a clearance SI is provided between the cover body 53 of the cover 15 and the overhead console 16 in the longitudinal direction. A clearance S2 is provided between the overlap portion 54 of the cover 15 and the overhead console 16 in the vertical direction.

### Method for Attaching the Cover

A method for attaching the cover 15 will now be described. Before the cover 15 is attached, the camera bracket 13b is fixed to the windshield 11, and the roof-side bracket 17 is fixed to the roof lining 20. The clips 18 are attached to the rear protrusions 52 of the cover 15.

The cover 15 is slid upward and rearward relative to the camera bracket 13b and the roof-side bracket 17. At this time, the front protrusions 51 of the cover 15 are inserted into the grooves 32 of the camera bracket 13b from the front. The front portion 15a of the cover 15 is thus attached to the camera bracket 13b. The rear protrusions 52 and the clips 18 attached to the rear protrusions 52 are inserted through the holes 75 of the roof-side bracket 17 from the front. The rear portion 15b of the cover 15 is thus attached to the roof-side bracket 17.

Specifically, when each clip 18 is inserted through the corresponding hole 75, the locking portions 82 are elastically deformed such that the locking arms 82a in each pair approach each other. Due to the elastic deformation of the locking portions 82, the maximum dimension of the enlarged portions 83 in the second direction Y becomes smaller than the dimension of the hole 75 in the second direction Y, so that the enlarged portions 83 can pass through the hole 75. When the enlarged portions 83 pass through the hole 75, the locking portions 82 are deformed by the restoring force so that the locking arms 82a in each pair are separated from each other. Accordingly, the maximum dimension of the enlarged portions 83 in the second direction Y is greater than the dimension of the hole 75 in the second direction Y.

When the enlarged portions 83 pass through the hole 75, the narrowed portions 84 of the locking portions 82 are located in the hole 75. The locking arms 82a are pressed against the inner circumferential surface 75a, which defines the hole 75, by the restoring force of the locking portions 82. Accordingly, the clips 18 are locked to the roof-side bracket 17, so that the rear portion 15b of the cover 15 is attached to the roof-side bracket 17.

### Operation of the Present Embodiment

Operation of the present embodiment will now be described.

The upper structure of the vehicle 10 includes the overhead console 16, provided on the ceiling Ra of the passenger compartment R, the camera unit 13, fixed to the upper portion of the windshield 11, and the cover 15, which covers the camera unit 13 from inside the passenger compartment R. The cover 15 and the overhead console 16 are arranged in the longitudinal direction of the vehicle 10.

The cover 15 of the present embodiment includes the cover body 53, located forward of the overhead console 16, and the overlap portion 54, which extends upward and rearward from the rear end of the cover body 53. The front portion 16b of the overhead console 16 covers the overlap portion 54 from below.

The overlap portion 54 of the cover 15 and the front portion 16b of the overhead console 16 thus overlap each other. Accordingly, even if the positional relationship between the cover 15 and the overhead console 16 varies in the vehicle longitudinal direction of the vehicle 10, it is possible to avoid the formation of a gap between the rear portion 15b of the cover 15 and the front portion 16b of the overhead console 16 in the vehicle longitudinal direction of the vehicle 10. This improves the aesthetic appearance of the upper structure of the vehicle 10.

### Advantages of the Present Embodiment

The present embodiment has the following advantages.
(1) The cover 15 includes the cover body 53, located forward of the overhead console 16, and the overlap portion 54, which extends upward and rearward from the rear end of the cover body 53. The front portion 16b of the overhead console 16 covers the overlap portion 54 from below.

With this configuration, the overlap portion 54 of the cover 15 and the front portion 16b of the overhead console 16 thus overlap each other. Accordingly, even if the positional relationship between the cover 15 and the overhead console 16 varies in the vehicle longitudinal direction of the vehicle 10, it is possible to avoid the formation of a gap between the rear portion 15b of the cover 15 and the front portion 16b of the overhead console 16 in the vehicle longitudinal direction of the vehicle 10. This improves the aesthetic appearance of the upper structure of the vehicle 10.

In addition, even though the clearance SI exists between the cover body 53 and the overhead console 16 in the longitudinal direction, the line of sight of an occupant of the vehicle 10 (indicated by arrows of long-dash short-dash lines in FIG. 7) is directed toward the overlap portion 54 located behind the clearance S1. Therefore, the occupant is more likely to perceive the continuity between the cover 15 and the overhead console 16. This further improves the aesthetic appearance of the upper structure of the vehicle 10.

Further, even though the clearance S2 exists between the overlap portion 54 and the overhead console 16 in the vertical direction, the clearance S2 is concealed by the overhead console 16 in the line of sight of the occupant. The clearance S2 is thus unlikely to be visually recognized by the occupant. This further improves the aesthetic appearance of the upper structure of the vehicle 10.
(2) The upper structure of the vehicle 10 includes the camera bracket 13b, fixed to the windshield 11, the roof lining 20, which forms the roof Ra of the passenger compartment R, and the roof-side bracket 17, fixed to the roof lining 20. The front portion 15a of the cover 15 is attached to the camera bracket 13b so as to be movable in the longitudinal direction of the vehicle 10. The rear portion 15b of the cover 15 is attached to the roof-side bracket 17 so as to be movable in the longitudinal direction of the vehicle 10.

According to this configuration, the cover 15 is movable in the longitudinal direction of the vehicle 10 while being attached to the camera bracket 13b and the roof-side bracket 17. Accordingly, the positional relationship between the cover 15 and the overhead console 16 in the longitudinal direction can be adjusted by moving the cover 15 in the longitudinal direction after the cover 15 and the overhead console 16 are assembled. This further improves the aesthetic appearance of the upper structure of the vehicle 10.
(3) The lower surface 53a of the cover body 53 is located on an identical plane with the lower surface 16a of the overhead console 16. The lower surface 53a of the cover body 53 and the lower surface 54a of the overlap portion 54 are smoothly connected to each other.

According to this configuration, since the lower surface 53a of the cover body 53 is located on the identical plane with the lower surface 16a of the overhead console 16, the continuity between the cover 15 and the overhead console 16 is improved. Further, since the lower surface 53a of the cover body 53 and the lower surface 54a of the overlap portion 54 are smoothly connected to each other, the boundary between the cover body 53 and the overlap portion 54 is visually softened, enhancing the continuity between the lower surface of the cover 15. This further improves the aesthetic appearance of the upper structure of the vehicle 10.
(4) The front portion 15a of the cover 15 is attached to the camera bracket 13b so as to be immovable in the vertical direction of the vehicle 10. The rear portion 15b of the cover 15 is attached to the roof-side bracket 17 so as to be immovable in the vertical direction of the vehicle 10.

According to this configuration, since the position of the cover 15 in the vertical direction of the vehicle 10 is fixed, a step is unlikely to be formed between the lower surface 53a of the cover body 53 and the lower surface 16a of the overhead console 16. This further improves the aesthetic appearance of the upper structure of the vehicle 10.
(5) The rear protrusions 52 are provided on the rear portion 15b of the cover 15. The elastically deformable clips 18 are attached to the rear protrusions 52. The holes 75, into which the rear protrusions 52 and the clips 18 are inserted, are formed in the roof-side bracket 17. By locking the clips 18 to the holes 75, the rear portion 15b of the cover 15 is attached to the roof-side bracket 17. Since the clips 18 are elastically deformable, the cover 15 is movable in the longitudinal direction of the vehicle 10 relative to the roof-side bracket 17.

According to this configuration, the cover 15 can be moved in the longitudinal direction of the vehicle 10 while being attached to the roof-side bracket 17 with a simple configuration.
(6) The rear portion 15b of the cover 15 is attached to the camera bracket 13b so as to be movable in the left-right direction of the vehicle 10. The rear portion 15b of the cover 15 is attached to the roof-side bracket 17 so as to be movable in the left-right direction of the vehicle 10.

According to this configuration, the cover 15 is movable not only in the longitudinal direction of the vehicle 10 but also in the left-right direction of the vehicle 10. Therefore, by moving the cover 15 in the left-right direction of the vehicle 10 after the assembly of the cover 15 and the overhead console 16, the center of the cover 15 and the center of the overhead console 16 in the left-right direction of the vehicle 10 can be adjusted to agree with each other. This further improves the aesthetic appearance of the upper structure of the vehicle 10.
(7) The cover 15 and the overhead console 16 are integrated so as to be arranged continuously in the longitudinal direction. Thus, the harness routed from the inside of the roof 12 to the inside of the cover 15 is prevented from being exposed to the passenger compartment R.
(8) In the conventional upper structure of the vehicle 10, in order to reduce the clearance between the rear portion 15b of the cover 15 and the front portion 16b of the overhead console 16 in the longitudinal direction, it is necessary to reduce the dimensional tolerances of components or to perform assembly work so that assembly errors are not caused. In contrast, in the present embodiment, since the cover 15 is movable in the longitudinal direction, it is possible to eliminate the clearance between the rear portion 15b of the cover 15 and the front portion 16b of the overhead console 16 in the longitudinal direction without reducing the dimensional tolerances of the components or performing the assembly work so that assembly errors are not caused.

### Modifications

The above-described embodiment may be modified as follows. The above-described embodiment and the following modifications can be combined as long as the combined modifications remain technically consistent with each other.

The device units are not limited to the camera unit 13 and the sensor unit 14. The device units may include, for example, an antenna for an ETC system.

The windshield-side bracket does not necessarily need to be formed by a part of a device unit. The windshield-side bracket may be provided separately from the device unit.

In each front attachment portion 10a, the front protrusions 51 may be provided on the camera bracket 13b, and the grooves 32 may be provided in the cover 15.

In each rear attachment portion 10b, the rear protrusions 52 may be provided on the roof-side bracket 17, and the holes 75 may be provided in the cover 15.

The roof-side bracket 17 may be formed integrally with the roof lining 20. When the roof lining 20 is made of a soft resin, the roof-side bracket 17 may be formed by hardening a part of the roof lining 20 with a hard resin.

The clip 18 may be integrally formed with the rear protrusion 52.

The front portion 15a of the cover 15 does not necessarily need to be attached to the camera bracket 13b so as to be movable in the longitudinal direction of the vehicle 10. The rear portion 15b of the cover 15 does not necessarily need to be attached to the roof-side bracket 17 so as to be movable in the longitudinal direction of the vehicle 10.

The front portion 15a of the cover 15 does not necessarily need to be attached to the camera bracket 13b so as to be movable in the left-right direction of the vehicle 10. The rear portion 15b of the cover 15 does not necessarily need to be attached to the roof-side bracket 17 so as to be movable in the left-right direction of the vehicle 10.

The front portion 15a of the cover 15 does not necessarily need to be attached to the camera bracket 13b so as to be immovable in the vertical direction of the vehicle 10. The rear portion 15b of the cover 15 does not necessarily need to be attached to the roof-side bracket 17 so as to be immovable in the vertical direction of the vehicle 10.

The lower surface 53a of the cover body 53 does not necessarily need to be located on an identical plane with the lower surface 16a of the overhead console 16.

The lower surface 53a of the cover body 53 and the lower surface 54a of the overlap portion 54 do not necessarily need to be smoothly connected to each other.

Although the embodiments have been described herein, it will be clear to those skilled in the art that the present invention may be embodied in different specific forms without departing from the spirit of the invention. The disclosure is not to be limited to the details given herein, but may be modified within the scope and equivalence of the appended claims.

What is claimed is:

1. A vehicle upper structure, comprising:
an overhead console provided on a ceiling of a passenger compartment;
a device unit fixed to an upper portion of a windshield; and
a cover that covers the device unit from inside the passenger compartment, wherein
the cover and the overhead console are arranged in a longitudinal direction of the vehicle,
the cover includes:
a cover body located forward of the overhead console; and
an overlap portion extending upward and rearward from a rear end of the cover body, and
a front portion of the overhead console covers the overlap portion from below.

2. The vehicle upper structure according to claim 1, further comprising:
a windshield-side bracket fixed to the windshield;
a roof lining forming the ceiling; and
a roof-side bracket fixed to the roof lining, wherein
a front portion of the cover is attached to the windshield-side bracket so as to be movable in the longitudinal direction of the vehicle, and
a rear portion of the cover is attached to the roof-side bracket so as to be movable in the longitudinal direction of the vehicle.

3. The vehicle upper structure according to claim 2, wherein
a lower surface of the cover body is located on an identical plane with a lower surface of the overhead console, and
the lower surface of the cover body and a lower surface of the overlap portion are smoothly connected to each other.

4. The vehicle upper structure according to claim 3, wherein
the front portion of the cover is attached to the windshield-side bracket so as to be immovable in a vertical direction of the vehicle, and
the rear portion of the cover is attached to the roof-side bracket so as to be immovable in the vertical direction of the vehicle.
